(19) United States
(12) Patent Application Publication
(10) Pub. No.: US 2024/0316895 A1
(43) Pub. Date: Sep. 26, 2024

(54) FLAT CONSTRUCTION ELEMENT, COMPRISING AN INSULATING PANEL, A COVER PLATE AND A MADE-TO-MEASURE DUCT COURSE

(71) Applicant: RC PANELS HOLDING B.V., LEMELERVELD (NL)

(72) Inventor: Carlos Klein, Lemelerveld (NL)

(73) Assignee: RC PANELS HOLDING B.V., Lemelerveld (NL)

(21) Appl. No.: 18/276,720

(22) PCT Filed: Feb. 8, 2022
(86) PCT No.: PCT/NL2022/050062

§ 371 Date: Aug. 10, 2023

(30) Foreign Application Priority Data
Feb. 12, 2021 (NL) 1043932

(51) Int. Cl. B32B 3/30; B32B 5/18; B32B 21/02; B32B 21/04; B32B 37/18; B32B 37/24

(52) U.S. Cl. CPC B32B 3/30; B32B 5/18; B32B 21/02; B32B 21/047; B32B 37/18; B32B 37/24; B32B 2037/243; B32B 2250/40; B32B 2255/102; B32B 2255/26; B32B 2266/0228; B32B 2307/304; B32B 2607/00

(57) ABSTRACT

Method for manufacturing a flat construction element, comprising in particular a sandwich panel provided with a made-to-measure duct course; the sandwich panel comprises an insulating panel made of expanded insulation material and a cover plate on the top side of the insulating panel, the method comprises the steps: providing a slot, from above, in the insulating panel in a pattern corresponding to the pattern of the desired duct course; arranging the cover plate over the insulating panel, so that the slot which has been provided is closed off by the cover plate and a closed duct and duct course are formed, and preferably applying a coating and/or reinforcement layer by means of introducing a coating-spray nozzle via one or more outlets of these ducts.

The invention relates to a method for manufacturing a flat construction element, in particular a sandwich panel provided with a made-to-measure duct course; the sandwich panel comprises at least an insulating panel made of expanded insulation material and a cover plate on the top side of the insulating panel in a main plane.

Netherlands patent NL1040849 discloses a method (vacuum method) for manufacturing a sandwich panel, namely a method for manufacturing a sandwich panel intended for use in commercial buildings and private dwellings, comprising providing an airtight substrate on which one or more cover plates and an insulating panel are arranged, with layers of adhesive in between. The assembly is covered with an airtight flexible covering film which is connected to the airtight substrate in an airtight manner. The airtight space formed by the flexible covering film and the airtight substrate including the sandwich panel is vacuumized during the time it takes for the layers of adhesive to cure. Lastly, the flexible covering film is removed and the sandwich panel is ready.

The present invention aims to provide an improved method for manufacturing a flat construction element, in particular a sandwich panel provided with a made-to-measure duct course; the sandwich panel comprises at least an insulating panel made of expanded insulation material and a cover plate on the top side of the insulating panel in a main plane. The duct course, comprising one or more ducts, may be reinforced and/or coated, and may be used for ventilation and/or for passing through cables and pipes for electrical power, water etc.

DE3414249 discloses a drainage mat which is composed of strips of rigid foam or insulating foam, in which the strips of rigid foam are connected to each other by a layer of kraft paper. The drainage mat is cast in concrete and/or mortar in order to form a balcony with moisture drainage. This drainage mat is unsuitable for use as an insulating panel in a sandwich panel manufactured using the vacuum method from NL1040849 because the strips of rigid foam connected by (kraft) paper will move and deform during the vacuumizing step, causing the ducts to deform and thus rendering them unsuitable for fitting and/or passing through cables or pipes. The ducts from DE3414249 are also unsuitable to fit a continuous made-to-measure duct course at predetermined and designated locations for use as a (ventilation) duct or for introducing and passing through cables or pipes for electrical power, water, etc.

The ducts from DE3414249 cannot be reinforced or made airtight by applying a reinforcement layer and/or coating.

To this end, a method is provided according to the invention for manufacturing a flat construction element, in particular a sandwich panel provided with a made-to-measure duct course; the sandwich panel comprises at least an insulating panel made of expanded insulation material and a cover plate on the top side of the insulating panel in a main plane, wherein the made-to-measure duct course is provided in the insulating panel, comprising the following steps:
providing an insulating panel made of expanded insulation material;
providing a slot, from above, in the main plane of the insulating panel in a pattern which corresponds to the pattern of the desired duct course;
arranging the cover plate over the main plane of the insulating panel, so that the slot which has been provided is closed off by the cover plate on the side of the main plane, thus forming a closed duct of the duct course.

By producing the duct course in the form of a slot in the main plane of the insulating panel, it is possible to form a closed made-to-measure duct course in a simple and inexpensive way, by connecting the cover plate to the insulating panel by means of the vacuum method and thus to close the slot and the duct course.

Preferably, the method according to the invention furthermore comprises the following step: providing a reinforcement layer and/or coating in a duct of the duct course formed by the slot and the cover plate. Due to the fact that the cover plate securely closes off the duct course after having been connected to the insulating panel by means of the vacuum method, it is readily possible to provide a reinforcement layer and/or coating in the duct course without these spilling out or to provide the duct course with another desired property, such as airtightness or water resistance. The strength of the sandwich panel is increased by providing a reinforcement layer in one or more ducts of the duct course.

In particular, the step of providing a reinforcement layer and/or coating in the duct course comprises: introducing a spray nozzle in a duct via one or more outlets of the duct course.

Due to the fact that the ducts are closed according to the vacuum method after the cover plate has been fitted, it is possible to provide a reinforcement layer and/or coating to the made-to-measure duct course by means of a spray nozzle and thus to improve the properties of the sandwich panel in a simple way, such as the strength, airtightness and/or water resistance.

Preferably, the reinforcement layer and/or coating is selected from: polyurethane, polyurea, polyester or epoxy.

It has been found that by applying these (synthetic) substances to the made-to-measure duct course, the strength of the sandwich panel is improved and at the same time the duct course is made suitable for the passage of gasses and liquids; or for fitting cables or pipes.

The invention will now be described in more detail by means of the following description of the figures, in which:

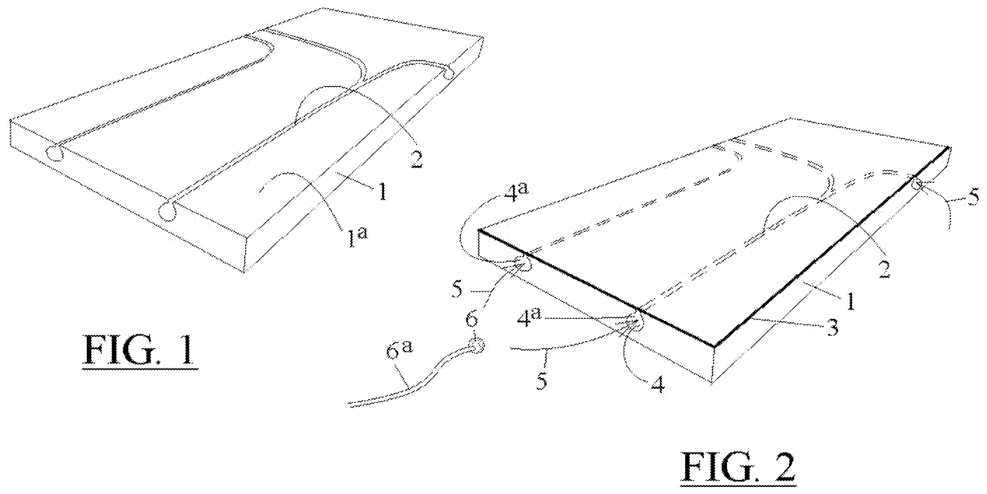

FIG. 1 illustrates the first step of the method according to the invention,

FIG. 2 illustrates the subsequent step of the method according to the invention.

FIG. 1 and FIG. 2 illustrate the steps of the method according to the invention for manufacturing a flat construction element, in particular a sandwich panel provided with a made-to-measure duct course 5; the sandwich panel comprises at least an insulating panel 1 made of expanded insulation material and a cover plate 3 on the top side of the insulating panel in a main plane 1a, wherein the made-to-measure duct course 5 is provided in the insulating panel, comprising the following steps:
providing a slot 2, from above, in the main plane 1a of the insulating panel in a pattern which corresponds to the pattern of the desired duct course 5; (FIG. 1)
arranging the cover plate over the main plane 1a of the insulating panel, so that the slot 2 which has been provided is closed off by the cover plate 3 on the side of the main plane 1a, thus forming a closed duct 4 and duct course 5. (FIG. 2)

Good results have been obtained with an insulating panel made of EPS (Expanded PolyStyrene, also referred to as EPS rigid foam) and a cover plate made of OBS (Oriented Strand Board) using the vacuum method.

Subsequently, a reinforcement layer and/or coating is provided, preferably in the one or more ducts 4 of the duct course 5 formed by the slots 2 and cover plate 3, for example made of polyurethane, polyurea, polyester or epoxy, by introducing a coating-spray nozzle 6 via one or more outlets 4a of these ducts 4 and supplying it with reinforcement material and/or coating material via a supply line 6a. The reinforcement material and/or the coating aims to improve the (compressive) strength, sturdiness, airtightness and/or water resistance of the duct walls. By applying a reinforcement layer, it is possible to (partly) compensate for the mechanical weakening of the sandwich panel resulting from the provision of slots and ducts.

In this way, the present invention provides a method for manufacturing, in particular, a sandwich panel provided with a made-to-measure duct course 5; the sandwich panel comprises at least an insulating panel 1 made of expanded insulation material and a cover plate 3 on the top side of the insulating panel in a main plane 1a, wherein the made-to-measure duct course 5 is provided in the insulating panel and is closed off by the cover plate 3 in such a way that the made-to-measure duct course 5 is suitable for ventilation air, liquids and/or for passing through wires and pipes for electrical power, water etc.; and wherein the made-to-measure duct course can readily be stiffened or reinforced to compensate for the mechanical weakening of the sandwich panel caused by the provision of the duct course; and wherein the made-to-measure duct course may be provided with another desired property by providing the duct wall of a duct of the duct course with a coating and/or reinforcement layer.

1. A method for manufacturing a flat construction element, in particular a sandwich panel provided with a made-to-measure duct course; the sandwich panel comprises at least an insulating panel made of expanded insulation material and a cover plate on the top side of the insulating panel in a main plane, wherein the made-to-measure duct course is provided in the insulating panel, comprising the steps:
providing an insulating panel made of expanded insulation material;
providing a slot, from above, in the main plane of the insulating panel in a pattern which corresponds to the pattern of the desired duct course; and
arranging the cover plate over the main plane of the insulating panel, so that the slot which has been provided is closed off on the side of the main plane by the cover plate, thus forming a closed duct of the duct course.

2. The method as claimed in claim 1, further comprising the step: providing a reinforcement layer and/or coating in a duct of the duct course formed by the slot and the cover plate.

3. The method as claimed in claim 2, wherein the step of providing a reinforcement layer and/or coating in the duct course comprises: introducing a spray nozzle in a duct via one or more outlets of the duct course.

4. The method as claimed in claim 3, wherein the reinforcement layer and/or coating is selected from: polyurethane, polyurea, polyester or epoxy.

5. A construction element manufactured by means of a method, in particular a sandwich panel provided with a made-to-measure duct course; the sandwich panel comprises at least an insulating panel made of expanded insulation material and a cover plate on the top side of the insulating panel in a main plane, wherein the made-to-measure duct course is provided in the insulating panel, the method comprising the steps of:
providing an insulating panel made of expanded insulation material;
providing a slot, from above, in the main plane of the insulating panel in a pattern which corresponds to the pattern of the desired duct course; and
arranging the cover plate over the main plane of the insulating panel, so that the slot which has been provided is closed off on the side of the main plane by the cover plate, thus forming a closed duct of the duct course.

6. The construction element of claim 5, wherein the method further comprises the step of providing a reinforcement layer and/or coating in a duct of the duct course formed by the slot and the cover plate.

7. The construction element of claim 6, wherein the step of providing a reinforcement layer and/or coating in the duct course further comprises: introducing a spray nozzle in a duct via one or more outlets of the duct course.

8. The construction element of claim 7, wherein the reinforcement layer and/or coating is selected from: polyurethane, polyurea, polyester or epoxy.
